(19) United States
(12) Patent Application Publication
(10) Pub. No.: US 2023/0085212 A1
(43) Pub. Date: Mar. 16, 2023

(54) CONTAINMENT BASIN SYSTEM AND METHOD

(71) Applicant: Miller Innovations, LLC, Orange Beach, AL (US)

(72) Inventor: Clint Miller, Orange Beach, AL (US)

(73) Assignee: Miller Innovations, LLC, Orange Beach, AL (US)

(21) Appl. No.: 17/942,613

(22) Filed: Sep. 12, 2022

Related U.S. Application Data
(60) Provisional application No. 63/242,613, filed on Sep. 10, 2021.

(51) Int. Cl. B08B 17/02; B65D 90/00; B65D 88/12

(52) U.S. Cl. CPC B08B 17/025; B65D 90/0033; B65D 88/123; B65D 88/129

(57) ABSTRACT

A containment basin system includes a basin and a lifting brace configured to be secured to and stabilize the basin for lifting and emptying operations. The basin includes a bottom wall, three or more side walls, and a lip extending around a top of all of the side walls. The bottom wall includes two transverse recesses. The lifting brace includes a base, two guide rails extending perpendicularly from the base, and two receptacles extending perpendicularly from the base. The two receptacles of the lifting brace are configured to engage the two transverse recesses of the basin. Each of the receptacles includes a central space dimensioned to receive a fork of a fork lift. The two guide rails each includes an upper guide and a lower guide configured to receive the lip of the basin therebetween.

### CROSS-REFERENCE TO RELATED APPLICATION

This application claims the benefit of and priority to U.S. Provisional Patent Application No. 63/242,613 filed on Sep. 10, 2021, which is incorporated herein by reference in its entirety.

### BACKGROUND

After concrete is poured at a construction site, certain parts of concrete trucks must be washed out to remove remaining concrete before it hardens. Concrete must also be washed off of other equipment such as wheelbarrows and other tools. Because concrete washout water is toxic, federal, state, and local laws and regulations require the collection and retention of concrete washout water and solids in leak proof containers so that these materials do not reach the soil or ground water.

For this reason, containment devices are placed at construction sites for the collection and storage of construction material waste. Existing containment devices include bags and cardboard box setups. These devices are undesirable, however, because the bags and cardboard box setups are dumped in landfills when full or when a project is complete without recycling any of the material that was collected, such as concrete. Other existing containment devices, such as large dumpsters and metal pans, are not cost effective and are too heavy to move around a job site without the use of heavy equipment.

### BRIEF DESCRIPTION OF THE DRAWINGS

FIG. 1 is a top perspective view of a basin of the containment basin system.

FIG. 2 is a bottom perspective view of the basin.

FIG. 3 is a top view of the basin.

FIG. 4 is a side view of the basin.

FIG. 5 is a bottom view of the basin.

FIG. 6 is a front view of the basin.

FIG. 7 is a cross-sectional view of the basin taken along line 7-7 in FIG. 4.

FIG. 8 is a cross-sectional view of the basin taken along line 8-8 in FIG. 6.

FIG. 9 is a top perspective view of an embodiment of the lifting brace of the containment basin system.

FIG. 10 is a side view of an embodiment of the lifting brace.

FIG. 11 is a top perspective view of an alternate embodiment of the lifting brace.

FIG. 12 is a right side view of an embodiment of the lifting brace.

FIG. 13 is a left side view of an embodiment of the lifting brace.

FIG. 14 is a top plan view of a first guide rail of the lifting brace.

FIG. 15 is a top plan view of a second guide rail of the lifting brace.

FIG. 16 is a top perspective view of the basin positioned in an embodiment of the lifting brace.

FIG. 17 is a bottom perspective view of the basin positioned in an embodiment of the lifting brace.

FIG. 18 is a top view of the basin positioned in an embodiment of the lifting brace.

FIG. 19 is a side view of the basin positioned in an embodiment of the lifting brace.

### DETAILED DESCRIPTION OF THE PREFERRED EMBODIMENTS

The containment basin system includes a basin and a lifting brace. Consistent with EPA regulations, the basin retains all liquids placed in the basin. The containment basin system is cost-effective, allows for movement of the basin around a job site without the need for heavy equipment, and allows for recycling bulk material collected in the basin.

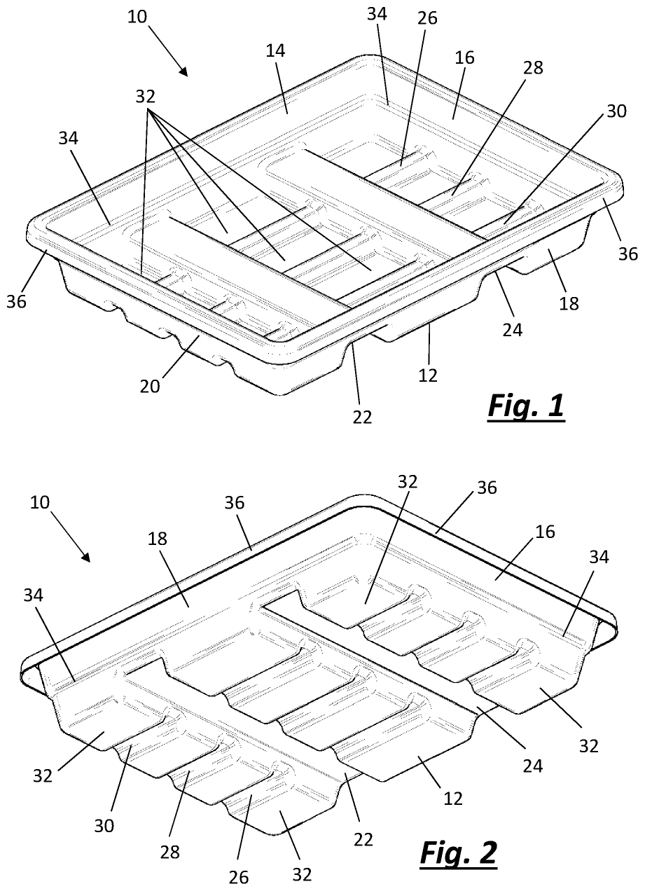

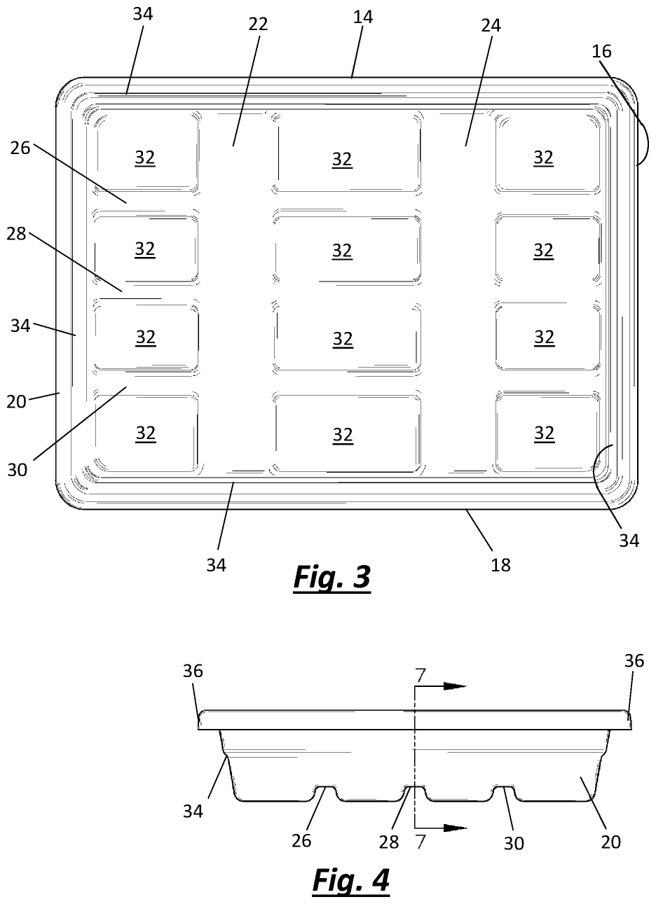

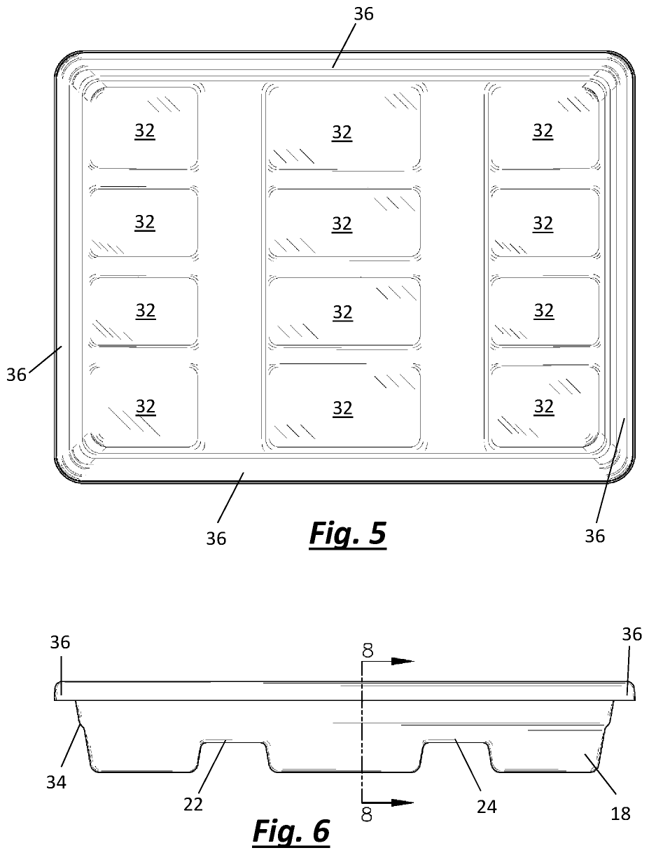

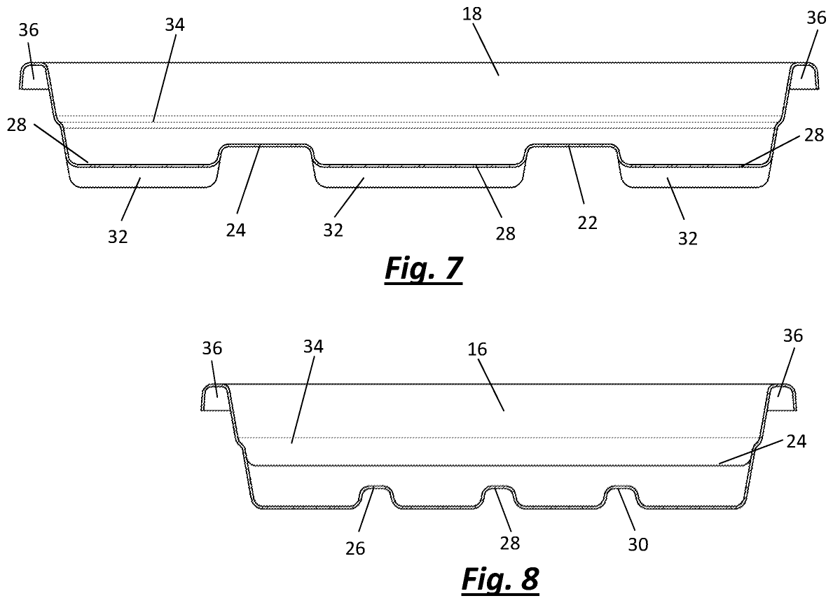

With reference to FIGS. 1-8, basin 10 includes bottom wall 12 and side walls 14, 16, 18, and 20 each extending vertically from bottom wall 12. Bottom wall 12 includes transverse recesses 22 and 24 extending between side walls 14 and 18. Transverse recesses 22, 24 are dimensioned to receive the forks of a fork lift. Bottom wall 12 also includes at least three ribs 26, 28, and 30 extending in a perpendicular direction relative to transverse recesses 22, 24. In one embodiment, ribs 26, 28, and 30 interconnect side wall 16, recesses 24 and 22, and side wall 20. The transverse recesses and the ribs may form a plurality of cavities 32 in bottom wall 12 for the collection of bulk waste. For example but not by way of limitation, basin 10 may include 3-10 ribs, or any subrange therein, and 10-35 cavities, or any subrange therein. As shown in FIGS. 7-8, transverse recesses 22, 24 may be positioned higher (i.e., further from the lower surfaces of cavities 32) than ribs 26, 28, and 30.

Basin 10 may also include shoulder 34 extending across all side walls 14, 16, 18, and 20. Shoulder 34 may be positioned between a top of each side wall and the upper surface of transverse recesses 22, 24. Basin 10 may further include lip 36 extending around a top end of all side walls 14, 16, 18, and 20. Lip 36 may be formed by an downward facing curvature at the top end of each side wall, as illustrated. Lip 36 may strengthen basin 10.

Side walls 14, 16, 18, 20 of basin 10 may have a height configured to fit under pump trucks to allow discharge for recycling. For example, side walls 14, 16, 18, 20 may have a height of 6 inches to 24 inches, or any subrange therein. In one embodiment, side walls 14, 16, 18, and 20 have a height of about 12-13 inches, or any subrange therein.

As illustrated, basin 10 may include numerous bevels to provide additional strength to basin 10. The bevels strengthen the basin to keep it rigid for transportation. For example, basin 10 may include beveled edges between bottom wall 12 and each of side walls 14, 16, 18, and 20. Basin 10 may also include beveled edges at the intersection of each of ribs 26, 28, and 30 with each transverse recess 22 and 24. Shoulder 34 may also include beveled surfaces. Ribs 26, 28, and 30 may strengthen basin 10 such that it does not flex when loaded or when being emptied.

Basin 10 may be formed of a plastic material, including but not limited to polyethylene. The inner surface of basin 10 (including the inner surfaces of bottom wall 12 and side walls 14, 16, 18, and 20) may include a smooth finish to increase or maximize the release of hardened material (e.g., concrete) when basin 10 is turned over to be emptied. Basin 10 may be lightweight to enable a user to easily move basin 10 when empty (or less full) from one location to another at a construction site instead of requiring lifting equipment (e.g., a fork lift). For example, basin 10 may have a weight of 25 lbs. to 75 lbs., or any subrange therein. In one embodiment, basin 10 may have a weight of about 50 lbs. Basin 10 may also be stackable.

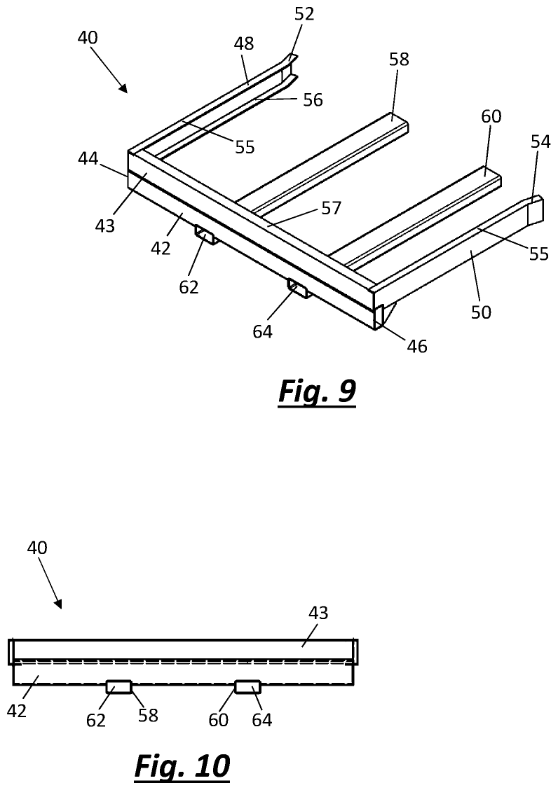

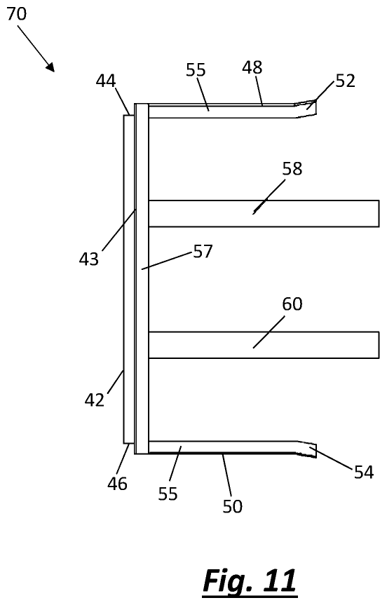

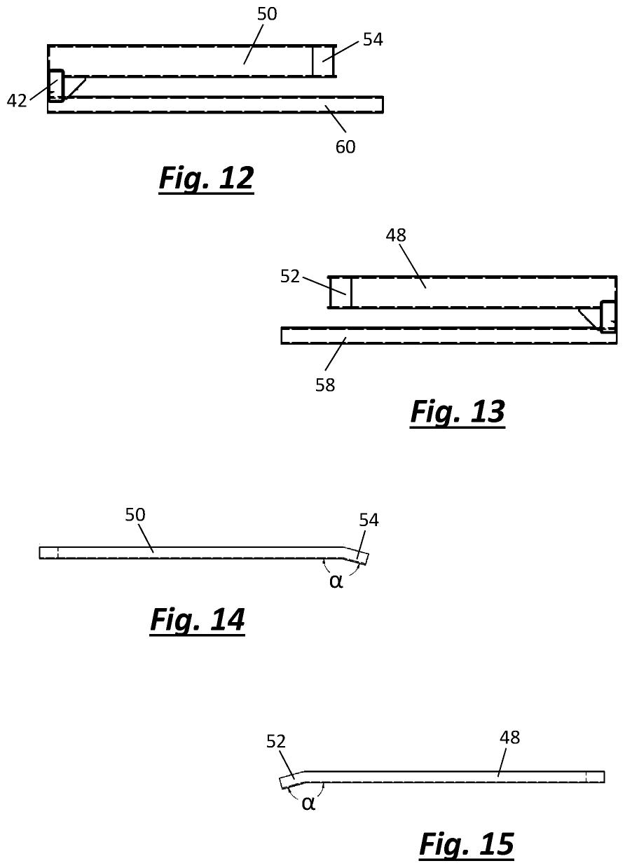

Referring now to FIGS. 9-15, lifting brace 40 of the containment basin system may include base 42 and transverse guide rail 43. Transverse guide rail 43 may extend in a parallel arrangement from first end 44 to second end 46, as shown in FIGS. 9 and 11. In some embodiments, base 42 and transverse guide rail 43 are formed of independent structures that are affixed together, such as by welding. In other embodiments, base 42 and transverse guide rail 43 are integrally formed of a single structure.

Guide rail 48 may be affixed to first end 44 and guide rail 50 may be affixed to second end 46. Guide rails 48, 50 may extend in a parallel direction relative to one another and in a perpendicular direction relative to base 42 and transverse guide rail 43. Guide rails 48, 50 may each include flared distal end 52, 54, respectively, as shown in FIGS. 9, 11, and 14-15. As shown in FIGS. 14 and 15, the flared distal ends 52 and 54 may each be turned at an angle α from the main portion of guide rails 48 and 50, respectively. In some embodiments, angle α is between 100° and 175°, or any subrange therein. In certain embodiments, angle α is about 165°.

In one embodiment, guide rails 48, 50 may each include upper guide 55 and lower guide 56, which may each be formed of an inward extension extending along the length of each guide rail. For example, upper and lower guides 55, 56 may each extend about 1 to about 3 inches inward from the inner surface of each guide rail 48, 50. Transverse guide rail 43 may also include upper guide 57 and a lower guide (not shown) similar to or identical to upper and lower guides 55, 56 of guide rails 48, 50. In one embodiment, a top surface of base 42 may define the lower guide of transverse guide rail 43.

Lifting brace 40 may further include receptacles 58 and 60 extending from base 42 in a perpendicular direction relative to base 42 and in a parallel direction relative to guide rails 48, 50. Receptacles 58 and 60 may have central space 62 and 64, respectively, configured to receive forks of a fork lift. Receptacles 58 and 60 may be disposed positioned lower than guide rails 48 and 50.

Guide rails 48 and 50, base 42, and transverse guide rail 43 may together form a U-shaped frame configured to engage lip 36 on three sides of basin 10. In one embodiment, lip 36 of basin 10 may fit between upper guide 55 and lower guide 56 of each guide rail 48 and 50. Receptacles 58 and 60 may be configured to slide below recesses 22, 24 of basin 10.

In one embodiment, the receptacles may be approximately the same length as the guide rails of the lifting frame. For example, the embodiment of the lifting frame 40 illustrated in FIG. 9 includes guide rails 48 and 50 that are approximately the same length as receptacles 58 and 60. In other embodiments, the receptacles may be longer than the guide rails. For example, the embodiment of the lifting frame 70 illustrated in FIGS. 11-13 include guide rails 48 and 50 that are shorter than receptacles 58 and 60. In both of these embodiments, the receptacles of the lifting frame are configured to support the full width of basin 10.

Lifting brace 40 may be formed of any durable material, such as steel or aluminum. Lifting brace 40 may be configured to lift basin 10 with contents resulting in a total weight of 3,000 lbs. to 5,000 lbs., or any subrange therein.

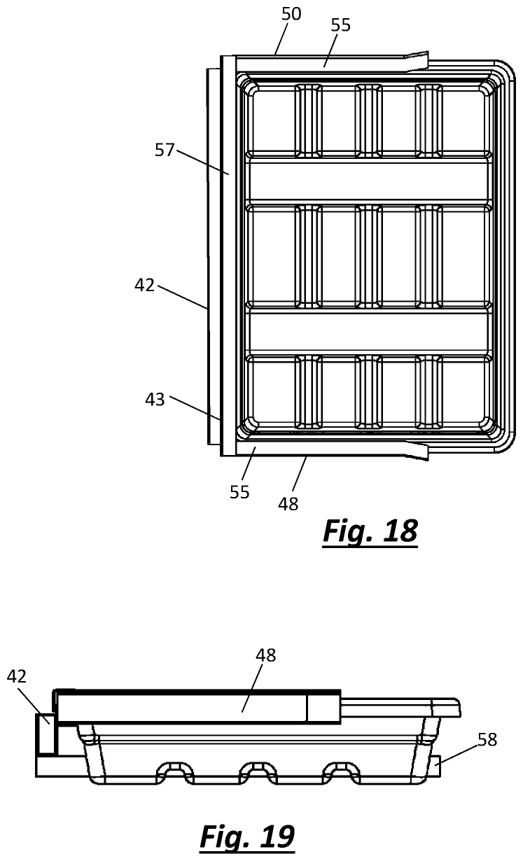

With reference to FIGS. 15-18, basin 10 may be placed at a construction site to collect construction materials such as paint, masonry mix, concrete washout, and sheetrock mud. When a user wishes to empty basin 10, lifting brace 40 or lifting brace 70 may be secured to basin 10 by sliding receptacles 58, 60 below transverse recesses 22, 24, respectively. The U-shaped frame of the lifting brace engages three side walls of basin 10. Specifically, guide rail 48 may slide along lip 36 on side wall 20 such that lip 36 is positioned between upper and lower guides 55, 56 of guide rail 48. Similarly, guide rail 50 may slide along lip 36 on side wall 16 such that lip 36 is positioned between upper and lower guides 55, 56 of guide rail 50. Flared distal ends 52, 54 of guide rails 48, 50 may assist the fork lift operator with properly positioning lifting brace 40 or 70 relative to the position of basin 10. Guide rails 48, 50 slide along lip 36 of side walls 20, 16 in this way until transverse guide rail 43 engages lip 36 on side wall 18 to position lip 36 of side wall 18 between upper guide 57 and the lower guide of transverse guide rail 43.

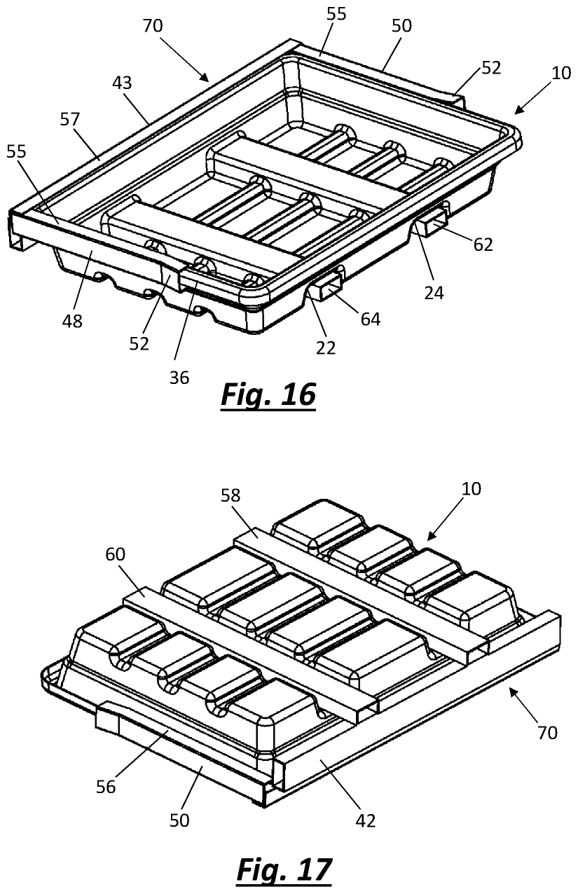

With lifting brace 40 or lifting brace 70 in a fully engaged position with basin 10 as illustrated, receptacles 58 and 60 may extend across the entire length of transverse recesses 22 and 24, respectively, in order to provide maximum lifting support and stability to basin 10 and its contents. With lifting brace 70 in a fully engaged position with basin 10 as illustrated in FIGS. 16-19, flared distal ends 52 and 54 of guide rails 48 and 50, respectfully, may be disposed at a position beyond a midpoint of the width of basin 10. With lifting brace 40 in a fully engaged position with basin 10, flared distal ends 52 and 54 of guide rails 48 and 50, respectfully, may be disposed at or near a distal corner of basin 10 such that guide rails 48 and 50 support the entire width of lip 36 on both sides.

The forks of a fork lift may then be inserted into the central spaces of receptacles 58, 60 for lifting the lifting brace 40 or 70 and basin 10. Receptacles 58, 60 and lower guides 56 of guide rails 48, 50 support the weight of the material contained within basin 10 (e.g., concrete). The fork lift may lift basin 10 for transportation. When basin 10 is properly positioned, the fork lift may then rotate lifting brace 40 or 70 and basin 10 to empty the contents of basin 10. Lifting brace 40 or 70 supports basin 10 as it is rotated to be emptied. Specifically, upper guides 55 of guide rails 48, 50 and upper guide 57 of transverse guide rail 43 retain lip 36 of basin 10. In one embodiment, lifting brace 40 or 70 and basin 10 may be rotated 180 degrees by the fork lift to empty basin 10.

The material contained in basin 10 (e.g., hardened concrete) is released when basin 10 is rotated upside down. In one embodiment, a mass of hardened concrete contained in basin 10 has weak areas directly above ribs 26, 28, 30 such that the hardened concrete breaks into smaller sections at these weak areas when basin 10 is rotated upside down. For example, the number of smaller sections of hardened concrete may equal the number of cavities 32 in bottom wall 12 of basin 10. These smaller sections are easier for recyclers to handle than a single larger mass of hardened concrete.

This novel containment basin system includes a light-weight basin separate from a strengthening lifting brace. The light weight of the basin allows users to transport the basin around a construction site or other job site without the use of heavy equipment, thereby reducing expenses. However, the lifting brace provides the necessary strength for emptying the basin containing bulk materials, such as hardened concrete. In one embodiment, the lifting brace may be configured to lift up to 5,000 pounds as shown in the attached structural analysis report, which is incorporated by reference. Additionally, a single lifting brace may be used to empty numerous basins. For example, a single lifting brace may be used to service a few hundred basins in an area.

Except as otherwise described or illustrated, each of the components in this device may be formed of aluminum, steel, another metal, plastic, or any other durable material. Each device described in this disclosure may include any combination of the described components, features, and/or functions of each of the individual device embodiments. Each method described in this disclosure may include any combination of the described steps in any order, including the absence of certain described steps and combinations of steps used in separate embodiments. Any range of numeric values disclosed herein includes any subrange therein. Plurality means two or more.

While preferred embodiments have been described, it is to be understood that the embodiments are illustrative only and that the scope of the invention is to be defined solely by the appended claims when accorded a full range of equivalents, many variations and modifications naturally occurring to those skilled in the art from a review hereof.

I claim:

1. A containment basin system, comprising:
a basin including a bottom wall, three or more side walls, and a lip extending around a top of all of the side walls; the bottom wall having two transverse recesses; wherein the transverse recesses are disposed on a lower portion of the basin; and
a lifting brace including a base, two guide rails extending in a perpendicular direction from the base, and two receptacles extending in the perpendicular direction from the base; wherein the two receptacles are configured to engage the two transverse recesses of the basin; wherein each of the two receptacles includes a central space dimensioned to receive a fork of a fork lift; wherein each of the two guide rails includes an upper guide and a lower guide configured to receive the lip of the basin therebetween.

2. The containment basin system of claim 1, wherein the basin includes four side walls.

3. The containment basin system of claim 2, wherein the two transverse recesses extend from a first side wall to a second side wall of the basin.

4. The containment basin system of claim 2, wherein the bottom wall of the basin further includes at least three ribs extending in a perpendicular direction relative to the transverse recesses.

5. The containment basin system of claim 4, wherein the transverse recesses and the ribs form a plurality of cavities in the bottom wall for collecting material.

6. The containment basin system of claim 2, wherein the lip of the basin is formed by a downward facing curvature at the top end of each of four side walls.

7. The containment basin system of claim 2, wherein the basin further includes a shoulder extending across all of the side walls between the top of each side wall and an upper surface of the transverse recesses.

8. The containment basin system of claim 2, wherein the basin includes a plurality of bevels for additional strength.

9. The containment basin system of claim 2, wherein the base of the lifting device includes a base beam and a transverse guide rail secured in a parallel configuration to the base beam; wherein the transverse guide rail includes an upper guide and a lower guide configured to receive the lip of the basin therebetween.

10. The containment basin of claim 2, wherein each of the two guide rails includes a flared distal end.

11. The containment basin of claim 2, wherein each of the flared distal ends is turned at an angle of about 165°.

12. The containment basin of claim 11, wherein distal ends of the receptacles of the lifting brace extend beyond the flared distal ends of the two guide rails.

13. The containment basin of claim 11, wherein the receptacles have approximately the same length as the two guide rails.

14. A containment basin system, comprising:
a basin including a bottom wall, four side walls, and a lip extending around a top of all of the side walls; wherein the bottom wall has two transverse recesses and at least three ribs; wherein the two transverse recesses extend from a first side wall to a second side wall;
wherein the ribs extend in a perpendicular direction relative to the transverse recesses to form a plurality of cavities in the bottom wall for the collection of material; wherein the transverse recesses are disposed on a lower portion of the basin; and
a lifting brace including a base, two guide rails extending in a perpendicular direction from the base, and two receptacles extending in the perpendicular direction from the base; wherein the two receptacles are configured to engage the two transverse recesses of the basin; wherein each of the two receptacles includes a central space dimensioned to receive a fork of a fork lift; wherein each of the two guide rails includes an upper guide and a lower guide configured to receive the lip of the basin therebetween.

15. The containment basin system of claim 14, wherein the lip of the basin is formed by a downward facing curvature at the top end of each of four side walls; and wherein the basin includes a plurality of bevels for additional strength.

16. The containment basin system of claim 14, wherein the basin further includes a shoulder extending across all of the side walls between the top of each side wall and an upper surface of the transverse recesses.

17. The containment basin system of claim 14, wherein the base of the lifting device includes a base beam and a transverse guide rail secured in a parallel configuration to the base beam; wherein the transverse guide rail includes an upper guide and a lower guide configured to receive the lip of the basin therebetween.

18. The containment basin of claim 14, wherein each of the two guide rails includes a flared distal end that is turned at an angle of about 165°.

19. A method of containing and disposing of construction materials, comprising the steps of:
a) providing a containment basin system comprising: a basin including a bottom wall, three or more side walls, and a lip extending around a top of all of the side walls, the bottom wall having two transverse recesses; wherein the transverse recesses are disposed on a lower portion of the basin; and a lifting brace including a base, two guide rails extending in a perpendicular direction from the base, and two receptacles extending in the perpendicular direction from the base; wherein the two receptacles are configured to engage the two transverse recesses of the basin; wherein each of the two receptacles includes a central space dimensioned to receive a fork of a fork lift; wherein each of the two guide rails includes an upper guide and a lower guide configured to receive the lip of the basin therebetween;
b) placing the basin at a construction site;
c) collecting construction materials in the basin;
d) securing the lifting brace to the basin by sliding the two receptacles of the lifting brace below the two transverse recesses of the basin; wherein the two guide rails slide along the lip of the basin;
e) inserting two forks of a fork lift into the receptacles of the lifting brace;
f) lifting the two forks in order to lift the lifting brace and the basin for transporting and emptying the basin.

20. The method of claim 19, wherein in step (a) the two guide rails include a flared distal end; and wherein in step (d) the flared distal ends assist with properly positioning the lifting brace relative to the basin.
